(19) United States
(12) Patent Application Publication
(10) Pub. No.: US 2014/0101174 A1
(43) Pub. Date: Apr. 10, 2014

(54) ELECTRONIC DEVICE AND MULTIMEDIA FILE SORTING METHOD

(71) Applicant: HTC Corporation, Taoyuan City (TW)

(72) Inventors: Jen-Yu TSAI, Taoyuan City (TW); I-Fen SHIH, Taoyuan City (TW)

(73) Assignee: HTC Corporation, Taoyuan City (TW)

(21) Appl. No.: 14/036,517

(22) Filed: Sep. 25, 2013

Related U.S. Application Data
(60) Provisional application No. 61/710,189, filed on Oct. 5, 2012.

(51) Int. Cl. G06F 17/30; G06F 7/24

(52) U.S. Cl. CPC G06F 17/30064; G06F 7/24
USPC 707/752

(57) ABSTRACT

A multimedia file sorting method for use in an electronic device is provided. The method has the following steps of: retrieving time information and location information of multimedia files stored in the electronic device; filtering the multimedia files according to the retrieved time information and the retrieved location information; and sorting the multimedia files into multiple groups according to similarities within both the retrieved time information and the retrieved location information.

### CROSS REFERENCE TO RELATED APPLICATIONS

This application claims the benefit of U.S. Provisional Application No. 61/710,189 filed Oct. 5, 2012, the entirety of which is incorporated by reference herein.

### BACKGROUND OF THE INVENTION

1. Field of the Invention

The present invention relates to an electronic device, and in particular to an electronic device and a multimedia file sorting method capable of sorting multimedia files into different groups according to time and geographical location information.

2. Description of the Related Art

With advances in technologies, mobile devices such as smart phones and tablet PCs, have become more and more popular. A mobile device is often used to capture pictures or download multimedia files, and the captured pictures and downloaded multimedia files can be embedded with time information and location information (e.g. GPS coordinates). However, a conventional mobile device cannot use the time information and location information to effectively sort the captured picture files and downloaded multimedia files, making it inconvenient for the user to view these multimedia files by meaningful events in the conventional mobile device.

### BRIEF SUMMARY OF THE INVENTION

A detailed description is given in the following embodiments with reference to the accompanying drawings.

In an exemplary embodiment, a multimedia file sorting method for use in an electronic device is provided. The method has the following steps of: retrieving time information and location information of multimedia files stored in the electronic device; filtering the multimedia files according to the retrieved time information and the retrieved location information; and sorting the multimedia files into multiple groups according to similarities within both the retrieved time information and the retrieved location information.

In another exemplary embodiment, a multimedia file sorting method for use in an electronic device is provided. The method comprises: arranging an event in a calendar application executed on the electronic device wherein the event in the calendar has a start time and an end time; retrieving multimedia files by the electronic device, wherein each of the multimedia files is embedded with time information and location information correspondingly; determining a reference region based on a reference location of the event; and sorting the multimedia files, which have the time information between the start time and the end time and have the location information within the reference region, into a first group.

In yet another exemplary embodiment, a multimedia file sorting method for use in an electronic device is provided. The method comprises: retrieving first multimedia files stored in the electronic device, wherein the retrieved first multimedia files are sorted into a first group, and the filenames of the first multimedia files comprise a first pattern; editing at least one of the first multimedia files and saving the edited first multimedia file as a second multimedia file with the first pattern; and sorting the second multimedia file into the first group according to the first pattern.

In yet another exemplary embodiment, a multimedia file sorting method for use in an electronic device is provided. The method comprises: retrieving first multimedia files stored in different physical folders of the electronic device; retrieving time information and location information of the first multimedia files by parsing all of the first multimedia files; and sorting the first multimedia files into at least one group according to similarities of the retrieved time information and/or the retrieved location information.

In an exemplary embodiment, an electronic device is provided. The electronic device comprises: a memory unit configured to store multimedia files; and a processor configured to retrieve time information and location information of the multimedia files stored in the memory unit, filter the multimedia files according to the retrieved time information and the retrieved location information, and sort the multimedia files into multiple groups according to similarities within both the retrieved time information and the retrieved location information.

In another exemplary embodiment, an electronic device is provided. The electronic device comprises: a memory unit configured to store multimedia files and a calendar application; and a processor configured to execute the calendar application, arrange an event in the calendar application, wherein the event in the calendar has a start time and an end time, wherein the processor further retrieves multimedia files, and each of the multimedia files is correspondingly embedded with time information and location information, wherein the processor further determines a reference region based on a reference location of the event, and sorts the multimedia files, which have the time information between the start time and the end time and the location information within the reference region, into a first group.

In yet another exemplary embodiment, an electronic device is provided. The electronic device comprises: a memory unit configured to store first multimedia files, wherein the retrieved first multimedia files are sorted into a first group, and filenames of the first multimedia files comprise a first pattern; and a processor configured to retrieve the first multimedia files, edit at least one of the first multimedia files, save the edited first multimedia file as a second multimedia file with the first pattern, and sort the second multimedia file into the first group according to the first pattern.

In yet another exemplary embodiment, an electronic device is provided. The electronic device comprises: a memory unit configured to store first multimedia files with different physical folders; and a processor configured to retrieve the first multimedia files, retrieve time information and location information of the first multimedia files by parsing all of the first multimedia files, and sort the first multimedia files into at least one group according to similarities of the retrieved time information and/or the retrieved location information.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an electronic device 100 according to an embodiment of the invention;

FIG. 2 is a diagram illustrating the sorting of photos by time according to an embodiment of the invention;

FIG. 3 is a diagram illustrating the sorting of photos by geographical location according to an embodiment of the invention;

FIGS. 4A to 4E are diagrams illustrating the sorting of photos by both time and geographical location according to an embodiment of the invention;

FIGS. 5A and 5B are diagrams illustrating the sorting of photos by events built into a calendar of the electronic device 100 according to an embodiment of the invention;

FIG. 6 is a diagram illustrating the sorting of photos into groups by filename according to an embodiment of the invention;

FIG. 7 is a diagram illustrating the sorting of photos saved in different physical folders according to an embodiment of the invention; and

FIG. 8 is a flow chart illustrating a multimedia file sorting method according to an embodiment of the invention;

FIG. 9 is a flow chart illustrating a multimedia file sorting method according to an embodiment of the invention;

FIG. 10 is a flow chart illustrating a multimedia file sorting method according to an embodiment of the invention; and

FIG. 11 is a flow chart illustrating a multimedia file sorting method according to an embodiment of the invention.

FIGS. 12A and 12B are diagrams illustrating auto-merging of different small events according to an embodiment of the invention.

FIGS. 12C and 12D are diagrams illustrating auto-merging of different small events according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

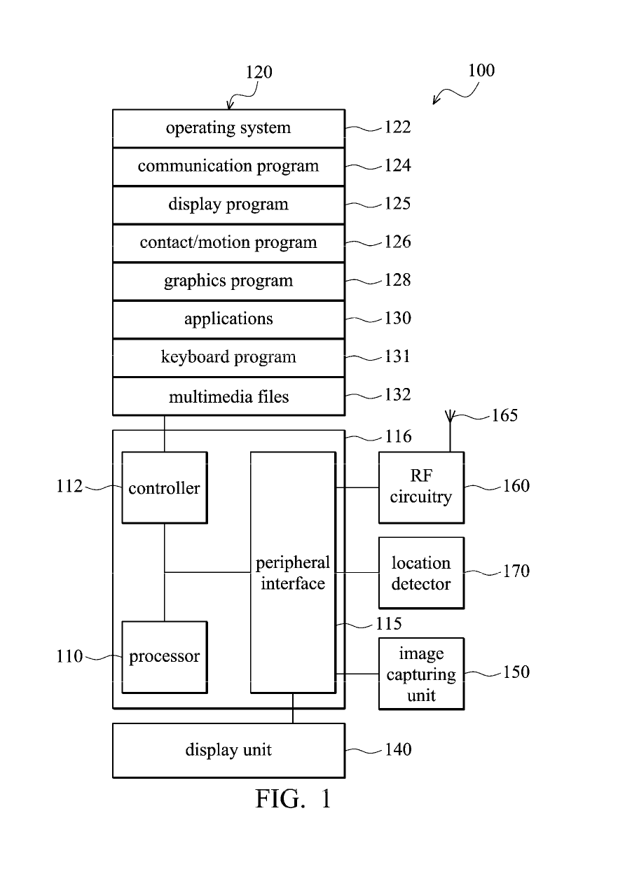

FIG. 1 is a schematic diagram illustrating an electronic device 100 according to an embodiment of the invention. The electronic device 100 may comprise a processor 110, a memory unit 120, a display screen 140, and an image capturing unit 150. In an exemplary embodiment, the electronic device 100 may be a personal computer or portable device such as mobile phone, tablet, digital camera/camcorder, game console or any suitable device equipped with image recording function. The processor 110 may be data processors, image processors, application processor and/or central processors, and is capable of executing one or more types of computer readable medium stored in the memory unit 120. Specifically, the electronic device 100 may further comprise an RF circuitry 160. In the embodiments, the display screen 140 may be a touch-sensitive screen.

In addition, the RF circuitry 160 may be coupled to one or more antennas 165 and may allow communications with one or more additional devices, computers and/or servers via a wireless network. The electronic device 100 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto.

When the display screen 140 is implemented as a touch-sensitive screen, it may detect contact and any movement or break thereof by using any of a plurality of touch sensitivity technologies now known or to be later developed, including, but not limited to, capacitive, resistive, infrared, and surface acoustic wave touch sensitivity technologies, as well as other proximity sensor arrays or other elements for determining one or more points of contact with the touch-sensitive screen. However, the touch-sensitive screen may also display visual output of the electronic device 100. In some other embodiments, the electronic device 100 may include a location detector 170 for supporting a location determining capability (e.g. determining GPS coordinates and/or longitude/latitude), such as that provided by a Global Positioning System (GPS), an assisted GPS, or a network-centric module.

The image capturing unit 150 may be one or more optical sensors configured to capture images. For example, the image capturing unit 150 may be one or more CCD or CMOS sensors, but the invention is not limited thereto.

The memory unit 120 may comprise one or more types of computer readable medium. The memory unit 120 may be high-speed random access memory (e.g. SRAM or DRAM) and/or non-volatile memory, such as flash memory (for example embedded multi-media card). The memory unit 120 may store program codes of an operating system 122, such as LINUX, UNIX, OS X, Android, iOS or WINDOWS operating system, or an embedded operating system such as VxWorks therein. The operating system 122 may executes procedures for handling basic system services and for performing hardware dependent tasks. The memory unit 120 may also store communication programs 124 for executing communication procedures. The communication procedures may be used for communicating with one or more additional devices, one or more computers and/or one or more servers. The memory unit 120 may comprise display programs 125, contact/motion programs 126 to determine one or more points of contact and/or their movement, and a graphics processing programs 128. The graphics processing programs 128 may support widgets, i.e., modules or applications with embedded graphics. The widgets may be implemented using JavaScript, HTML, Adobe Flash, or other suitable computer programming languages and technologies.

The memory unit 120 may also comprise one or more application programs 130. For example, application programs stored in the memory unit 120 may be telephone applications, email applications, text messaging or instant messaging applications, memo pad applications, address books or contact lists, calendars, picture taking and management applications, and music playback and management applications. The application programs 130 may comprise a web browser (not shown in FIG. 1) for rendering pages written in the Hypertext Markup Language (HTML), Wireless Markup Language (WML), or other languages suitable for composing web pages or other online content. The memory unit 120 may further comprise keyboard input programs (or a set of instructions) 131. The keyboard input programs 131 operates one or more soft keyboards. In addition, the captured pictures or downloaded multimedia files can be also stored in the memory unit 120 (e.g. multimedia files 132).

It should be noted that each of the above identified programs and applications correspond to a set of instructions for performing one or more of the functions described above. These programs (i.e., sets of instructions) need not be implemented as separate software programs, procedures or modules. The various programs and sub-programs may be rearranged and/or combined. Various functions of the electronic device 100 may be implemented in software and/or in hardware, including one or more signal processing and/or application specific integrated circuits.

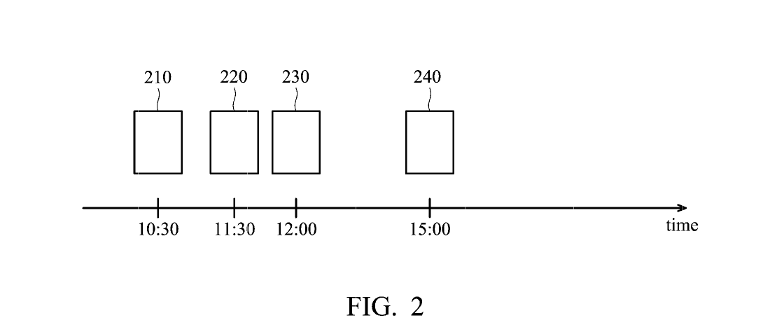

FIG. 2 is a diagram illustrating the sorting of multimedia files by time according to an embodiment of the invention. When an electronic device 100 is used to capture photos or videos, the electronic device 100 may embed information corresponding to the local time and geographical location (e.g. GPS coordinates, or latitude/longitude) in each captured photo or video (e.g. in the header of the captured photo/video/audio) upon creating these photos and videos. Thus, the electronic device 100 may sort the captured photos into various groups according to each type of embedded information (e.g. local time and/or geographical location of the electronic device 100). Alternatively, the electronic device 100 may receive multimedia files with time and geographical information from other sources (e.g. from a smart phone, or the internet), and sort the received multimedia files by time and/or geographical information. For example, the electronic device 100 may be a personal computer, a notebook, a smart phone, a tablet PC, or any other device capable of sorting multimedia files by time and/or geographical information.

However, when the number of captured multimedia files is large, it is difficult for a user to arrange these multimedia files. If the multimedia files can be sorted into some meaningful groups which are sorted by event, the usage experience can be enhanced. In an embodiment, the electronic device 100 may sort the multimedia files by analyzing the media time of each multimedia file. Generally, photos associated with the same event may have a similar media time. Thus, the electronic device 100 may sort these multimedia files having similar media time into the same group. Specifically, taking photos as an example, the electronic device 100 may determine a reference photo having a reference media time first, and filter photos having similar media times (e.g. within a predetermined period before and/or after the media time of a reference photo) into the same group. As illustrated in FIG. 2, the reference media time of the reference photo 210 is 10:30, and the predetermined period is 2 hours, for example. Accordingly, the electronic device 100 may select the photo 220 to be within the same group as the reference photo 210 since the media time of the photo 220 is 11:30, which is within the predetermined period after the media time of the photo 210. Then, the electronic device 100 may regard the photo 220 as the reference photo, and the reference time is changed to 11:30. Similarly, the photo 230 is selected to be within the same group of the photos 210 and 220 since the media time of the photo 230 is 12:00. After adding the photo 130 into the group containing photos 210 and 220, the reference time is changed to the media time of the photo 230. It should be noted that the photo 240 is not selected since the media time of the photo 240 is 3 hours later than that of the photo 230.

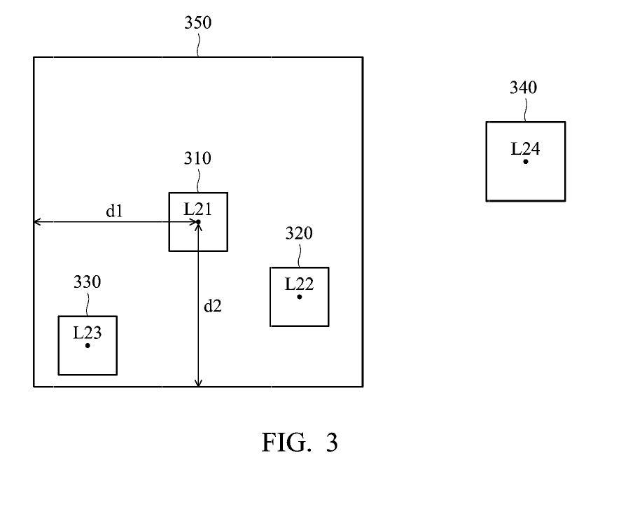

FIG. 3 is a diagram illustrating the sorting of multimedia files by geographical location according to an embodiment of the invention. In an embodiment, the electronic device 100 may comprise a global positioning system (GPS), and thus the electronic device 100 may further embed geographical information (e.g. GPS coordinate) in the header of the captured photos. Additionally, photos associated with the same event may have similar geographical locations, and thus the electronic device 100 may sort these photos having similar geographical locations into the same group. Specifically, the electronic device 100 may determine a reference photo first, and then filter photos having similar geographical locations (e.g. within a predetermined distance away from the geographical location of a reference photo) into the same group. As illustrated in FIG. 3, the reference photo 310 is captured at the geographical location L1, and the predetermined distance is 10 km, for example. Then, the electronic device 100 may retrieve the geographical location of each remaining photo (e.g. photos 320-340) and calculate the distance between each remaining photo and the reference photo 310. As illustrated in FIG. 3, the distance between the geographical location L22 of the photo 320 and the geographical location L21 of the photo 310 is shorter than the predetermined distance (e.g. 10 km), and the electronic device 100 may add the photo 320 to the same group as the photo 310. Further, the geographical location L23 of the photo 330 is within a reference region 350 (e.g. a 20 km*20 km square) based on the geographical location L21, the electronic device 100 may sort the photo 330 into the same group as the photo 310. Additionally, the geographical location L24 of the photo 340 is not within the reference region 350, and thus the photo 340 will not be added to the group of the photo 310. It should be noted that the range of the reference region is not limited to a 20 km*20 km square, and the range of the reference region can be configured by the user. For example, the reference region can be an exact geographical area (e.g. a district, a village, a county, a city, or a state), a region within a predetermined distance, or a region within a range of latitude/longitude values.

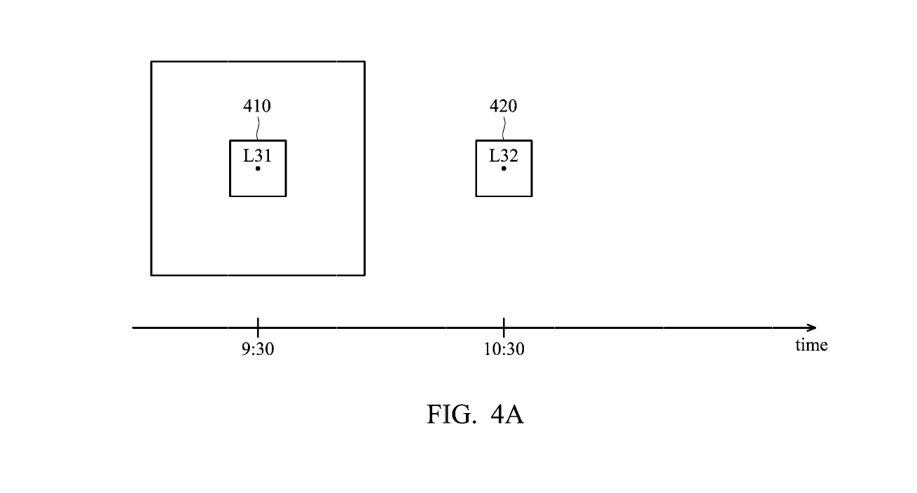

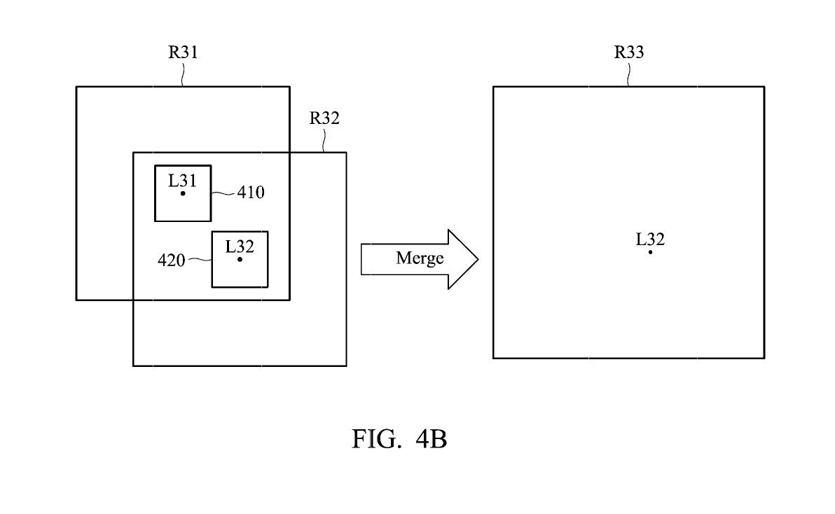

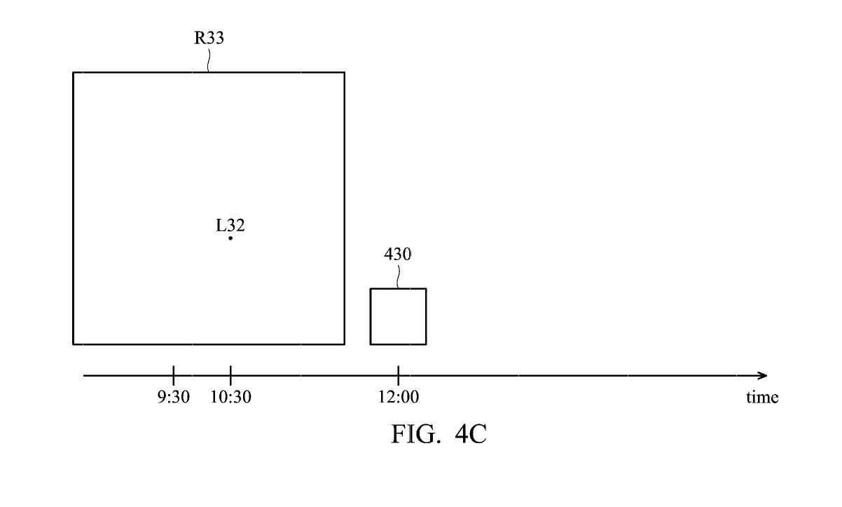

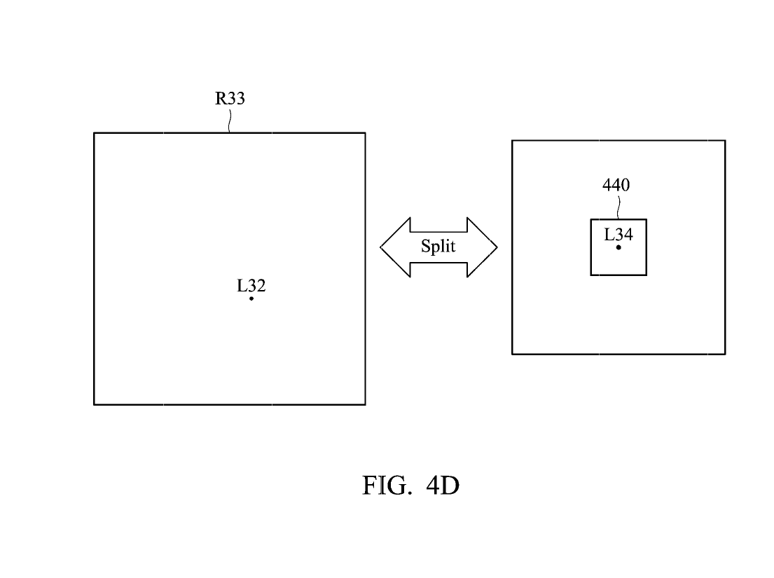

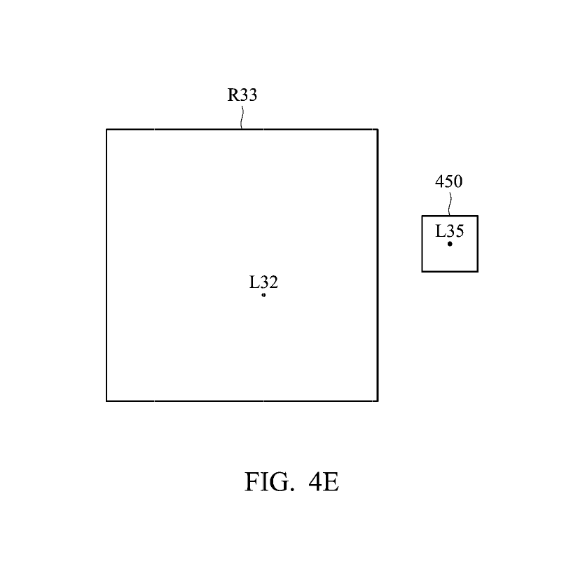

FIGS. 4A to 4E are diagrams illustrating the sorting of multimedia files by both time and geographical location according to an embodiment of the invention. As described in embodiments of FIG. 2 and FIG. 3, photos can be sorted into corresponding groups by time or geographical location, respectively. The electronic device 100 may further sort the photos into corresponding groups by both time and geographical location. Briefly, a candidate photo is only added into the same group as the reference photo when the media time and/or the geographical location of the candidate photo meets the criteria described in the embodiments of FIG. 2 and FIG. 3. As illustrated in FIG. 4A, a photo 410 is captured at 9:30 at a geographical location L31. The electronic device 100 may determine the reference region R31 based on the geographical location L31. Then, a photo 420 is captured at 10:30 at a geographical location L32. Since the period between the media time of the photos 410 and 420 is shorter than the predetermined period (e.g. 2 hours) and the geographical location L32 is within the reference region R31, the electronic device 100 may add the photo 420 into the same group as the photo 410, and change the reference time to 10:30. It should be noted that another reference region R32 can be obtained based on the geographical location L32. After merging the photos 410 and 420 into the same group, the electronic device 100 may also generate a new reference region R33 by extending the outer boundary of the reference regions R31 and R32, as illustrated in FIG. 4B.

However, the electronic device 100 may sometimes capture a photo 430 without any geographical info (e.g. the GPS/network unit of the electronic device 100 is turned off), as illustrated in FIG. 4C. Thus, the electronic device 100 may only sort the photo 430 by its media time (e.g. 12:00). Since the period between the media time of the photo 430 and the reference time (e.g. 10:30) is shorter than the predetermined period (e.g. 2 hours), the electronic device 100 may still add the photo 430 into the same group as the photos 410 and 420, and change the reference time to 12:00. As illustrated in FIG. 4D, a photo 440 is further captured at 17:00. Since the media time of the photo 440 is 4 hours later than the reference time 12:00, the electronic device 100 will not add the photo 440 into the group of the photos 410 to 430. Instead, the electronic device 100 will start a new group based on the photo 440. As illustrated in FIG. 4E, a photo 450 is further captured at 12:30 at a geographical location L35. Since the geographical location L35 is outside the reference region R33, the electronic device 100 may not add the photo 450 into the group of the photos 410 to 430.

In view of the above, embodiments of FIGS. 4A to 4E have described various ways for managing photos into different groups according to time and/or geographical location of the photos. It should be noted that the predetermined distance/region/period can be set manually by a user or defined by default values as described above. In the following sections, more methods for managing the multimedia files will be described.

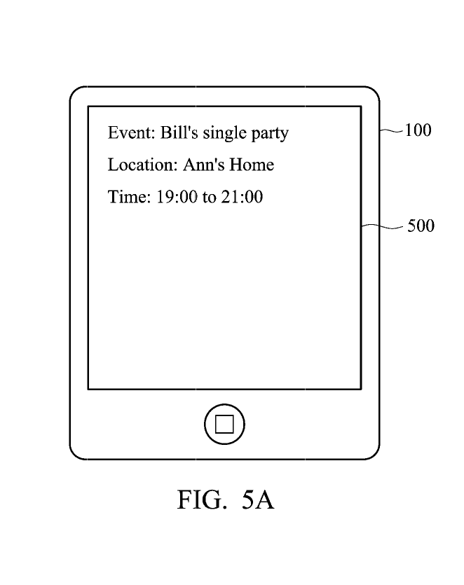

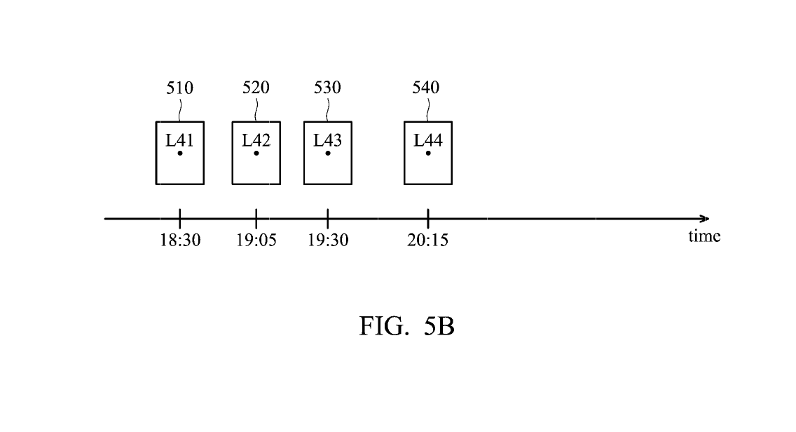

FIGS. 5A and 5B are diagrams illustrating the sorting of multimedia files by events built into a calendar of the electronic device 100 according to an embodiment of the invention. In an embodiment, a user may arrange a schedule in a calendar application executed on the electronic device 100, and an event 500 in the calendar may have a start time and an end time. That is, the electronic device 100 may filter photos during the period between the start time and the end time of the event. Then, the electronic device 100 may determine the corresponding geographical location of each filtered photo, and the sorting method as described in FIG. 3 can be used here. That is, the electronic device 100 may determine the photos which meet the time/geographical location criteria to be within the same group. Additionally, the group of photos associated with the event may be not strictly limited within the period between the start time and the end time. For example, when a user plans to join a party which is scheduled to be held at 19:00 to 21:00 as illustrated in FIG. 5A, the user may arrive the location of the party at 18:30 (i.e. 30 minutes earlier than the start time of 19:00) and start to take photos (e.g. photo 510-540), where the photo 510 is taken at a geographical location L41 at 18:30, and photos 520-540 are taken at geographical locations L42, L43 and L44 at 19:05, 19:30 and 20:15, respectively, as illustrated in FIG. 5B. However, the photos (e.g. photo 510) taken before the start time should correspond to the party. The electronic device 100 may determine whether the period between the media time of the photo 510 and the start time of the party is smaller than a predetermined period (e.g. 60 minutes). If so, the electronic device 100 may further determine whether the geographical location L41 of the photo 510 is within the reference region based on the photos 520-540. If so, the electronic device 100 may add the photo 510 into the same group of the photos 520-540. If the media time or the geographical location of the photo 510 does not meet the aforementioned criterion, the electronic device 100 may not add the photo 510 to the same group as the photos 520-540.

In another example, the user may leave the party at 20:45 (i.e. 15 minutes before the end time of 21:00), and take a photo 550 at a geographical location L45 at 21:45. Since the media time of the photo 550 is within the predetermined period (e.g. 60 minutes) after the planned time for the end of the party, the electronic device 100 may further determine whether the geographical location L45 is within the reference region based on the photos 520-540. If so, the electronic device 100 may add the photo 550 into the same group as the photos 520-550. Otherwise, the electronic device 100 may sort the photo 550 into another new group.

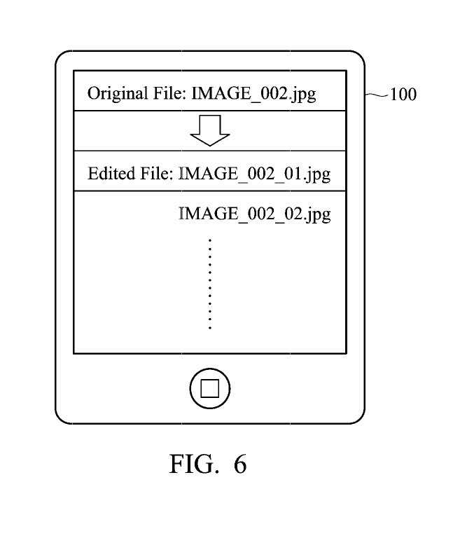

FIG. 6 is a diagram illustrating the sorting of multimedia files into groups by filename according to an embodiment of the invention. In an embodiment, a user may want to edit/crop/trim photos stored in the electronic device 100 and save the edited photos as other image files. These new image files may have filenames having an identical pattern (e.g. identical prefix or suffix with increasing numbers) or the same file path related to the original photos. The electronic device 100 may sort these image files having the identical pattern or the same file path into the same group as their original photos since these filenames may be meaningful to the user. For example, as illustrated in FIG. 6, an original image file IMAGE_{—}002.jpg has been edited by the user, and has been saved into IMAGE_{—}002_{—}01.jpg and IMAGE_{—}002_{—}02.jpg with time and/or geographical information of the original image file IMAGE_{—}002.jpg. Since the edited image files have the same time and geographical information as the original image file, the electronic device 100 may add the edited image files IMAGE_{—}002_{—}01.jpg and IMAGE_{—}002_{—}02.jpg into the same group as the original image file IMAGE_{—}002.jpg.

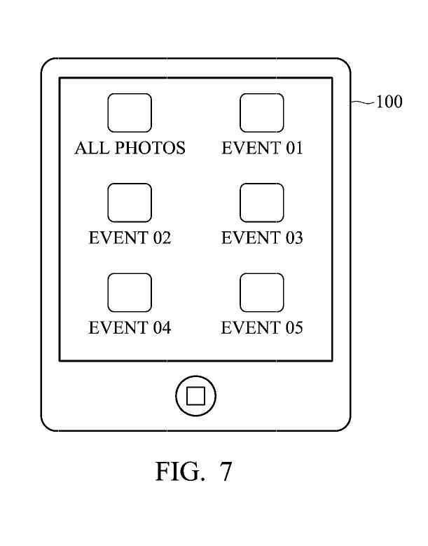

FIG. 7 is a diagram illustrating the sorting of multimedia files saved in different physical folders according to an embodiment of the invention. In an embodiment, the photos stored in the electronic device 100 may have been arranged by the user, and thus the photos may be located in different physical folders (e.g. sub-directories under the DCIM directory in Android systems, but not limited). The electronic device 100 may parse all the photos stored in different physical folders and retrieve the media time and the geographical location of each parsed photo. Then, the electronic device 100 may start to sort the parsed photos by the aforementioned methods, and thus new, different photo groups can be built. Additionally, the electronic device 100 may build a virtual album marked by a representative thumbnail (e.g. from a reference photo in each group) for each new group, as illustrated in FIG. 7. Thus, when the electronic device 100 enters the album view, not only the thumbnails for original physical folders but also the thumbnails of the new groups will be illustrated on the screen. Although new groups are built, the photos in the original physical folders still remain unchanged.

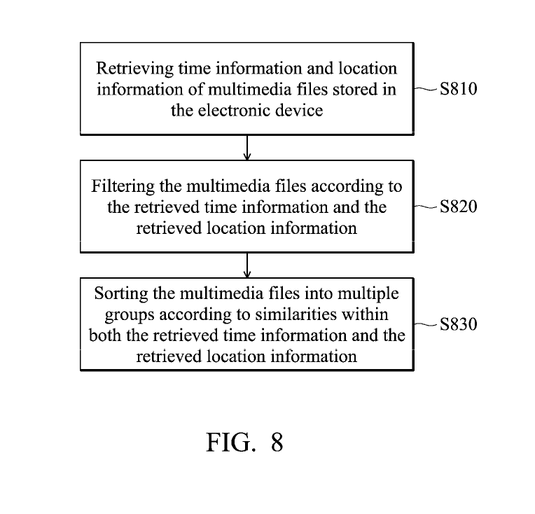

FIG. 8 is a flow chart illustrating a multimedia file sorting method according to an embodiment of the invention. Referring to FIGS. 4A-4E and FIG. 8, in step S810, the processor 110 may retrieve time information and location information of the multimedia files stored in the memory unit 120. In step S820, the processor 110 may filter the multimedia files according to the retrieved time information and the retrieved location information. For example, the retrieved time information should be within a predetermined time period from a reference time, and the retrieved location information should be within a reference region away from a reference location. In step S830, the processor 110 may sort the multimedia files into multiple groups according to similarities within both the retrieved time information and the retrieved location information. It should be noted that the above-mentioned reference time and reference location can be retrieved from a reference multimedia file (e.g. a first multimedia file during the process), and thereby the processor 110 may filter the multimedia files having similar time and location information, and sort the filtered multimedia files into the same group.

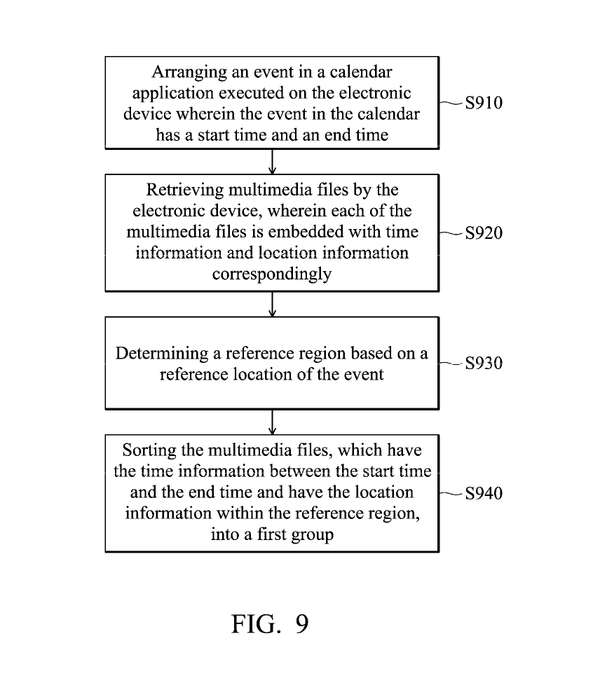

FIG. 9 is a flow chart illustrating a multimedia file sorting method according to an embodiment of the invention. Referring to both FIGS. 5A-5B and FIG. 9, in step S910, the processor may execute a calendar application and arrange an event in the calendar application, wherein the event in the calendar has a start time and an end time. In step S920, the processor 110 may retrieve multimedia files (e.g. by the image capturing unit 170 or downloaded from the network), wherein each of the multimedia files is correspondingly embedded with time information and location information. In step S930, the processor 110 may determine a reference region based on a reference location (e.g. a reference GPS coordinate) of the event. In step S940, the processor 110 may sort the multimedia files, which have time information between the start time and the end time, and have location information within the reference region, into a first group.

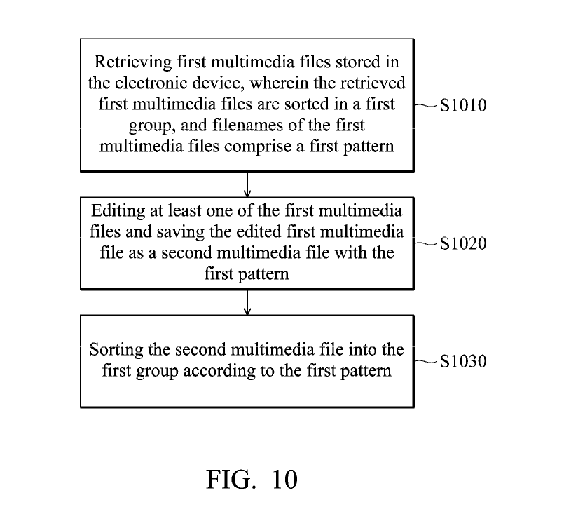

FIG. 10 is a flow chart illustrating a multimedia file sorting method according to an embodiment of the invention. Referring to FIG. 6 and FIG. 10, in step S1010, the processor 110 may retrieve first multimedia files stored in the memory unit 120, wherein the retrieved first multimedia files are sorted into a first group, and the filenames of the first multimedia files comprise a first pattern (e.g. an identical pattern). In step S1020, at least one of the first multimedia files may be edited, and the edited first multimedia file may be saved as a second multimedia file with the first pattern. It should be noted that the second multimedia file may also have the same time information and location information as the edited first multimedia file. In step S1030, the processor 110 may sort the second multimedia file into the first group according to the first pattern. Specifically, since the second multimedia file has similar time and location information, and an identical filename pattern, with the first multimedia files, the processor 110 may easily add the second multimedia file into the first group of the first multimedia files.

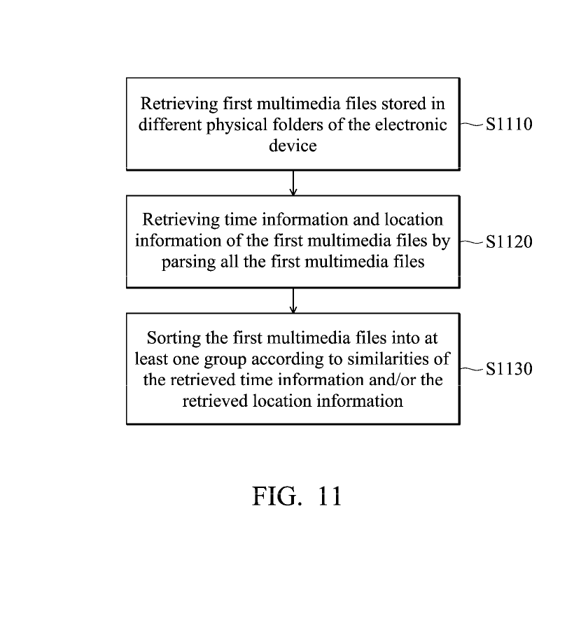

FIG. 11 is a flow chart illustrating a multimedia file sorting method according to an embodiment of the invention. Referring to FIG. 7 and FIG. 11, in step S1110, the processor 110 may retrieve first multimedia files stored in different physical folders of the electronic device. In step S1120, the processor 110 may retrieve time information and location information of the first multimedia files by parsing all of the first multimedia files. In step S1130, the processor 110 may sort the first multimedia files into at least one group according to similarities of the retrieved time information and/or the retrieved location information. In other words, in step S1130, the aforementioned methods described in FIGS. 2-10 can be used to sort the first multimedia files.

In view of the above, various methods have been proposed for sorting photos into different groups according to time and geographical location information. Specifically, the similarities between the time and location information can be used to sort the photos into meaningful groups (e.g. by the temporal similarities and/or spatial similarities). In addition, an identical filename pattern can also be used to sort the multimedia files. However, for those skilled in the art, it is appreciated that the invention is not limited to photos and the aforementioned methods can also be applied to multimedia files (e.g. photo/video/audio files). In other words, each new group may comprise photos, videos and/or audio files.

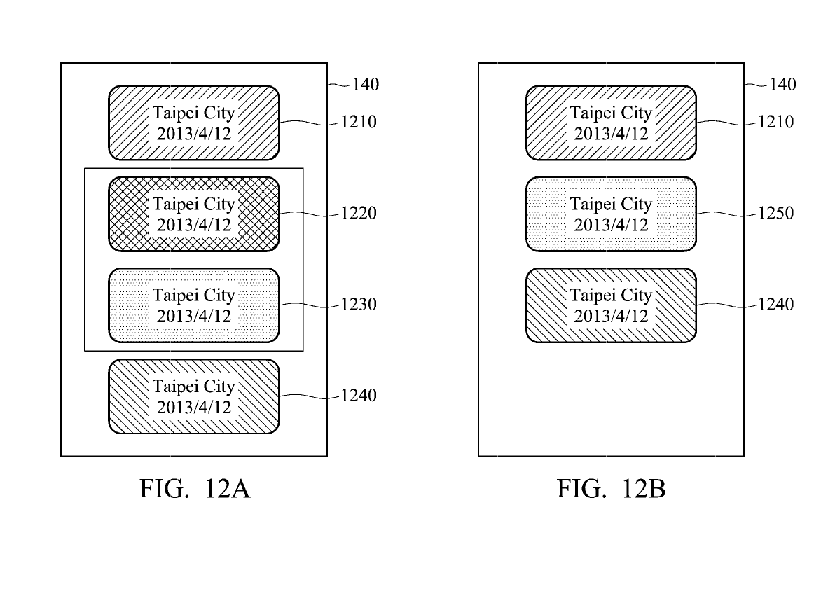

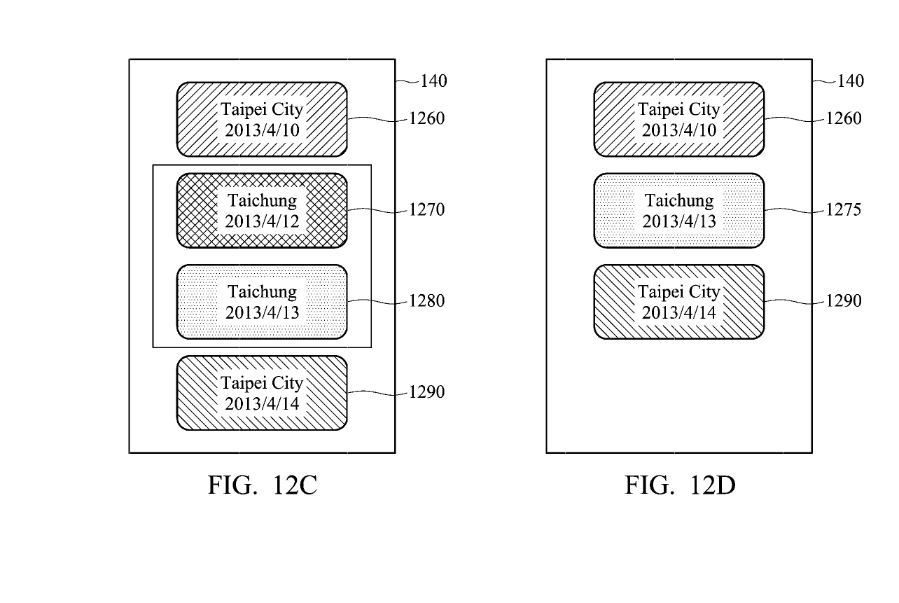

FIGS. 12A and 12B are diagrams illustrating auto-merging of different small events according to an embodiment of the invention. In an embodiment, when the multimedia files in the electronic device 100 have been classified into different groups according to the above-mentioned rules in FIG. 1-7, a group merging rule can be further applied to these events to prevent from presenting too many odd/small events, which may be taken accidentally, meaninglessly, or randomly, to the user. Specifically, the odd/small events can be further merged into another event by size, date and continuity. For example, as illustrated in FIG. 12A, the multimedia files stored in the electronic device 100 can be stored into event 1210, 1220, 1230 and 1240. It should be noted that all the multimedia files in the events 1210-1240 are created at April, 12, 2013, and the sizes of the events 1210-1240 are 100, 2, 3, and 300 (MBytes), respectively. However, the events 1220 and 1230 may only include a very limited number of photos, and the sizes of the events 1220 and 1230 are small. Further, the events 1220 and 1230 are both taken at the same day. Accordingly, the events 1220 and 1230 can be regarded as sibling events with the same condition, and the electronic device 100 may automatically merge the events 1220 and 1230 into a joint event 1250, which has a total size of 5 MB, as illustrated in FIG. 12B. Specifically, when the events have sizes less than a predetermined size (e.g. 24 MB) and are taken in the same date, the electronic device 100 may merge the events into another event automatically. Moreover, when an event has a size larger than a predetermined size (e.g. 24 MB), the event can be regarded as a highlighted event.

In addition, the criteria for merging events may be the number of photos in the events. For example, as illustrated in FIG. 12A, the multimedia files stored in the electronic device 100 can be stored into event 1210, 1220, 1230 and 1240. It should be noted that all the multimedia files in the events 1210-1240 are created at Apr., 12, 2013, and the number of photos in the events 1210-1240 are 30, 5, 3, and 18, respectively. However, the numbers of photos in the events 1220 and 1230 are smaller than a predetermined number (e.g. 6 photos, not limited), and thus the electronic device 100 may regard the events 1220 and 1230 as sibling events with a small number of photos, and automatically merge the events 1220 and 1230 into a joint event 1250.

FIGS. 12C and 12D are diagrams illustrating auto-merging of different small events according to another embodiment of the invention. For example, as illustrated in FIG. 12C, the multimedia files stored in the electronic device 100 can be stored into event 1260, 1270, 1280 and 1290. It should be noted that all the multimedia files in the events 1260, 1270, 1280 and 1290 are created at different dates and/or different locations, and the sizes of the events 1210-1240 are 100, 2, 3, and 300 (MBytes), respectively. Although the events 1270 and 1280 were created at different dates, the events 1270 and 1280 were both created at Taichung. In addition, the events 1270 and 1280 may only include a very limited number of photos, and the sizes of the events 1270 and 1280 are small. Accordingly, the events 1270 and 1280 can be regarded as sibling events with the same condition, and the electronic device 100 may automatically merge the events 1270 and 1280 into a joint event 1275, which has a total size of 5 MB, as illustrated in FIG. 12D. Specifically, when the events have sizes less than a predetermined size (e.g. 24 MB) and are taken at the same location, the electronic device 100 may merge the events into another event automatically. Moreover, when an event has a size larger than a predetermined size (e.g. 24 MB), the event can be regarded as a highlighted event. In some embodiments, the number of photos in the events 1260, 1270, 1280, and 1290 are 30, 5, 3, and 18, respectively. Similar to the embodiment in FIGS. 12 and 12B, in some embodiments, when the number of photos in the events taken at the same location is smaller than a predetermined number (e.g. 6 photos, not limited), the events (e.g. events 1270 and 1280) will be merged into a joint event (e.g. event 1275) by the electronic device 100.

In addition, the user may also manage events on the electronic device 100 through manual operations (e.g. via a user interface), such as merge, split, rename, add, delete, create, show/hide virtually. It should be noted that the aforementioned manual operations will not affect the multimedia files stored in the electronic device 100. For example, the user may combine two entire events together, which are related or non-related, by the “merge” operation. The user may also split some multimedia files in an event to other event(s), which are related or non-related. The user may also add some multimedia files into an event from other events, and it is possible for each multimedia file to exist in multiple events. The user may also give a custom name to a designated event.

The user may also delete the multimedia files in an event, and it indicates removing the relations between the multimedia files and the event. When the multimedia files in the event have no relation with other events, the multimedia files will be deleted physically. In another embodiment, the user may create an event with a given name, and may manage the multimedia files in the created event by manual operations, such as merge, split, add, and delete. In yet another embodiment, the user may also designate which event to show or hide via a user interface.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multimedia file sorting method for use in an electronic device, comprising:
retrieving time information and location information of multimedia files stored in the electronic device;
filtering the multimedia files according to the retrieved time information and the retrieved location information; and
sorting the multimedia files into multiple groups according to similarities within both the retrieved time information and the retrieved location information.

2. The multimedia file sorting method as claimed in claim 1, further comprising:
creating the multimedia files by the electronic device;
retrieving local time and a corresponding location of the electronic device; and
embedding the local time and the corresponding location of the electronic device to the multimedia files upon creating the multimedia files.

3. The multimedia file sorting method as claimed in claim 1, further comprising:
determining the similarities within the retrieved time information according to a predetermined time period; and
determining the similarities within the retrieved location information according to a reference region.

4. The multimedia file sorting method as claimed in claim 3, further comprising:
determining a reference multimedia file from the multimedia files;
retrieving reference time information and a reference location of the reference multimedia file;
determining the reference region according to the reference location of the reference multimedia file;
determining whether the time information of each of the remaining multimedia files is within the predetermined time period from the reference time information;
determining whether the location information of each of the remaining multimedia files is within the reference region away from the reference location; and
sorting the multimedia files, which have the time information within the predetermined time period from the reference time information and the location information within the reference region away from the reference location, into the same group as the reference multimedia file.

5. The multimedia file sorting method as claimed in claim 3, wherein the reference region is defined as a region within a predetermined distance away from the reference location.

6. A multimedia file sorting method for use in an electronic device, comprising:
arranging an event in a calendar application executed on the electronic device wherein the event in the calendar has a start time and an end time;
retrieving multimedia files by the electronic device, wherein each of the multimedia files is correspondingly embedded with time information and location information;
determining a reference region based on a reference location of the event; and
sorting the multimedia files, which have the time information between the start time and the end time and have the location information within the reference region, into a first group.

7. The multimedia file sorting method as claimed in claim 6, further comprising:
sorting the multimedia files, which have the time information within a predetermined time period before the start time or after the end time, and have the location information within the reference region, into the first group.

8. A multimedia file sorting method for use in an electronic device, comprising:
retrieving first multimedia files stored in the electronic device, wherein the retrieved first multimedia files are sorted into a first group, and filenames of the first multimedia files comprise a first pattern;
editing at least one of the first multimedia files and saving the edited first multimedia file as a second multimedia file with the first pattern; and
sorting the second multimedia file into the first group according to the first pattern.

9. The multimedia file sorting method as claimed in claim 8, wherein the second multimedia file comprises the same time information and location information as the edited first multimedia file.

10. A multimedia file sorting method for use in an electronic device, comprising:
retrieving first multimedia files stored in different physical folders of the electronic device;
retrieving time information and location information of the first multimedia files by parsing all of the first multimedia files; and
sorting the first multimedia files into at least one group according to similarities of the retrieved time information and/or the retrieved location information.

11. An electronic device, comprising:
a memory unit configured to store multimedia files; and
a processor configured to retrieve time information and location information of the multimedia files stored in the memory unit, filter the multimedia files according to the retrieved time information and the retrieved location information, and sort the multimedia files into multiple groups according to similarities within both the retrieved time information and the retrieved location information.

12. The electronic device as claimed in claim 11, wherein the processor further retrieves local time and a corresponding location of the electronic device and embeds the local time and the corresponding location of the electronic device to the multimedia files upon creating the multimedia files.

13. The electronic device as claimed in claim 11, wherein the processor further determines the similarities within the retrieved time information according to a predetermined time period, and determines the similarities within the retrieved location information according to a reference region.

14. The electronic device as claimed in claim 13, wherein the processor further determines a reference multimedia file from the multimedia files, retrieves reference time information and a reference location of the reference multimedia file, determines the reference region according to the reference location of the reference multimedia file, determines whether the time information of each of the remaining multimedia files is within the predetermined time period from the reference time information, determines whether the location information of each of the remaining multimedia files is within the reference region away from the reference location, and sorts the multimedia files, which have the time information within the predetermined time period from the reference time information and the location information within the reference region away from the reference location, into the same group as the reference multimedia file.

15. The electronic device as claimed in claim 11, wherein the reference region is within a predetermined distance away from the reference location.

16. An electronic device, comprising:
a memory unit configured to store multimedia files and a calendar application; and
a processor configured to execute the calendar application, arrange an event in the calendar application, wherein the event in the calendar has a start time and an end time,
wherein the processor further retrieves multimedia files, and each of the multimedia files is correspondingly embedded with time information and location information,
wherein the processor further determines a reference region based on a reference location of the event, and sorts the multimedia files, which have the time information between the start time and the end time and the location information within the reference region, into a first group.

17. The electronic device as claimed in claim 16, wherein the processor further sorts the multimedia files, which have the time information within a predetermined time period before the start time or after the end time and have the location information within the reference region, into the first group.

18. An electronic device, comprising:
a memory unit configured to store first multimedia files, wherein the retrieved first multimedia files are sorted into a first group, and filenames of the first multimedia files comprise a first pattern; and
a processor configured to retrieve the first multimedia files, edit at least one of the first multimedia files, save the edited first multimedia file as a second multimedia file with the first pattern, and sort the second multimedia file into the first group according to the first pattern.

19. The electronic device as claimed in claim 18, wherein the second multimedia file comprises the same time information and location information as the edited first multimedia file.

20. An electronic device, comprising:
a memory unit configured to store first multimedia files with different physical folders; and
a processor configured to retrieve the first multimedia files, retrieve time information and location information of the first multimedia files by parsing all of the first multimedia files, and sort the first multimedia files into at least one group according to similarities of the retrieved time information and/or the retrieved location information.
